(19) United States
(12) Patent Application Publication
(10) Pub. No.: US 2012/0317275 A1
(43) Pub. Date: Dec. 13, 2012

(54) METHODS AND DEVICES FOR NODE DISTRIBUTION

(76) Inventors: Chon-Jei LEE, Kaohsiung City (TW); Jung-Yang Kao, Wandan Township (TW); Jih-Sheng Tu, Yilan County (TW)

(21) Appl. No.: 13/339,143

(22) Filed: Dec. 28, 2011

(30) Foreign Application Priority Data
Jun. 9, 2011 (TW) 100120106

(51) Int. Cl. G06F 15/173

(52) U.S. Cl. 709/224

(57) ABSTRACT

Methods for node distribution in a P2P network system and include the steps of: mapping nodes to a numerical space respectively, wherein each node has a neighborhood table recorded a certain number of nodes and the certain number of nodes are close to the node along one of two sides in increasing and decreasing direction; performing a search process to find a plurality of reference nodes, wherein any two consecutive reference nodes are a first reference node and a second reference node, and the second reference node is the node in the neighborhood table of the first reference node and a distance between the second and the first reference node conforms to a predetermined condition; finding two positioning reference nodes; mapping a target node to a target value, and locating the target node in a position corresponding to the target value and informing the reference nodes of the position.

### CROSS REFERENCE TO RELATED APPLICATIONS

This Application claims priority of Taiwan Patent Application No. 100120106, filed on June 9, 2011, the entirety of which is incorporated by reference herein.

### BACKGROUND

1. Technical Field

The present disclosure relates to a method and device for node distribution, and more particular relates to a method and device for distribution of nodes through a peer-to-peer (P2P) network.

2. Description of the Related Art

In recent years, because of the rapid growth of development of the Internet, a large number of distributed applications have recently emerged as a way, wherein file sharing in peer-to-peer (P2P) network systems is widely used.

The P2P network systems may be classified as structured and unstructured P2P systems. The unstructured P2P systems record the nodes and share the files by the trackers. The advantage of using the unstructured P2P systems is that design and management thereof are simple. But, the disadvantage is that the unstructured P2P systems may not provide query services. The structured P2P service networks may use distributed hash table (DHT) to route messages sent between the nodes efficiently, and utilize the positions in which the nodes are placed to distribute the query evenly.

For the structured P2P service network implemented through the distributed hash table, a hash key is associated with a file and each node in the system is responsible for storing a certain range of hash keys of a hash space. A lookup operation looking for a particular key is routed through the P2P network to the node responsible for the key using a specific routing algorithm Insignificant node identifiers (node IDs) are assigned to each node in the P2P network and are mapped to the same hash space as the hash keys. That is, each node is responsible for storing all resources that have a certain range of hash keys. Typically, in a DHT resources are assigned to a node having an insignificant node identifier (node ID) that is closest, according to some location determination, to the file ID. The service networks with different distributed hash tables may perform operations through network topologies, for example, Chord, content-addressable network (CAN), Pastry and other systems.

However, there are disadvantages in the structured P2P systems based on the distributed hash table. For example, the structured P2P systems may not support the keyword query effectively, because the main design principle of the structured P2P systems is that the structured P2P systems may generate a key for the entire file, thus, the systems may not operate effectively for the keyword query. Certainly, the structured P2P service networks based on the distributed hash table may not provide the services of query by content (QBC) for processing similarity queries.

On the other hand, some of the structured P2P systems, such as topologically-aware content-addressable networks (Topologically-Aware CAN), may cause the nodes to be distributed in the network unevenly, and a certain nodes may be overloaded.

Therefore, how to distribute the nodes evenly and significantly in the topology and support the services of query by content in the structured P2P systems of the distributed hash table is one of the important research questions for current research and development of the structured P2P systems.

### SUMMARY

Methods and devices for node distribution, and computer program products thereof are provided.

In an embodiment of a node distribution method, the method is performed in at least one node distribution management device in a peer-to-peer (P2P) network system, and comprises: mapping all of the nodes in a P2P network to a numerical space respectively, wherein each node has a neighborhood table which are recorded a certain number of nodes, and the certain number of nodes recorded in the neighborhood table are close to the node along one of two sides in increasing and decreasing directions; performing a search process to find a plurality of reference nodes distributed along the direction in the numerical space, wherein any two consecutive reference nodes in a plurality of reference nodes are a first reference node and a second reference node, and the second reference node is the node which is in the neighborhood table of the first reference node and a distance between the second reference node and the first reference node conforms to a predetermined condition; finding two positioning reference nodes, wherein the distance conforms to the predetermined condition from the reference nodes; mapping a target node to a target numerical value between two positioning reference nodes, and locating position of the target node in a position corresponding to the target numerical value in the P2P network; and informing the reference nodes of the position of the target node.

In an embodiment of a peer-to-peer (P2P) network system, the P2P network system includes a plurality of nodes, joining or leaving the P2P network, wherein each node has a neighborhood table which are recorded a certain number of nodes and the certain number of nodes recorded in the neighborhood table are close to the node along one of two sides in increasing and decreasing directions; a node distribution management device, comprising: a mapping unit, configured to map all of the nodes in a P2P network to the numerical space respectively; a search unit, configured to find a plurality of reference nodes distributed along the numerical direction in the numerical space, wherein any two consecutive reference nodes in a plurality of reference nodes are a first reference node and a second reference node, and the second reference node is the node which is in the neighborhood table of the first reference node and a distance between the second reference node and the first reference node conforms to a predetermined condition; a positioning unit, configured to find two positioning reference nodes, wherein the distance conforms to the predetermined condition from the reference nodes, and the mapping unit maps a target node which wants to join the P2P network to a target numerical value between two positioning reference nodes; the positioning unit locates the target node in a position corresponding to the target numerical value in the P2P network, and informs the reference nodes of the position of the target node.

Methods for node distribution may take the form of a program code embodied in a tangible media. When the program code is loaded into and executed by a machine, the machine becomes an apparatus for practicing the disclosed method.

### BRIEF DESCRIPTION OF THE DRAWINGS

The present application can be more fully understood by reading the subsequent detailed description and examples with references made to the accompanying drawings, wherein:

FIG. 1 is a schematic diagram for illustrating nodes joining to a P2P network system according to an embodiment of the present application; and

FIG. 2A is a schematic diagram illustrating an embodiment of a numerical space of the present application; and

FIG. 2B is a schematic diagram illustrating an embodiment of a numerical space of the present application; and

FIG. 3 is a schematic diagram illustrating an embodiment of a node distribution management device of the present application; and

FIG. 4 is a flowchart illustrating an embodiment of a search process of the present application; and

FIG. 5A is an example for illustrating a process where a node joins a P2P network according to an embodiment of the present application; and

FIG. 5B illustrates in more detail the process illustrated in FIG. 5A; and

FIG. 5C illustrates in more detail the process illustrated in FIG. 5A to FIG. 5B; and

FIG. 5D illustrates in more detail the process illustrated in FIG. 5A to FIG. 5C; and

FIG. 6 is a flowchart illustrating an embodiment of the document mapping and linking process of the present application; and

FIG. 7 is a flowchart illustrating an embodiment of a document query of the present application; and

FIG. 8 is a schematic diagram illustrating the similarity query according to the method of the node distribution of the present application; and

FIG. 9 is a flowchart illustrating an embodiment of load balance of the present application; and

FIG. 10 is a schematic diagram illustrating the node distribution reaching balance distribution according to the method of the node distribution of the present application; and

FIGS. 11˜13 are schematic diagrams illustrating the condition of the node distribution after the nodes leave the network of the present application.

### DETAILED DESCRIPTION OF THE EMBODIMENTS

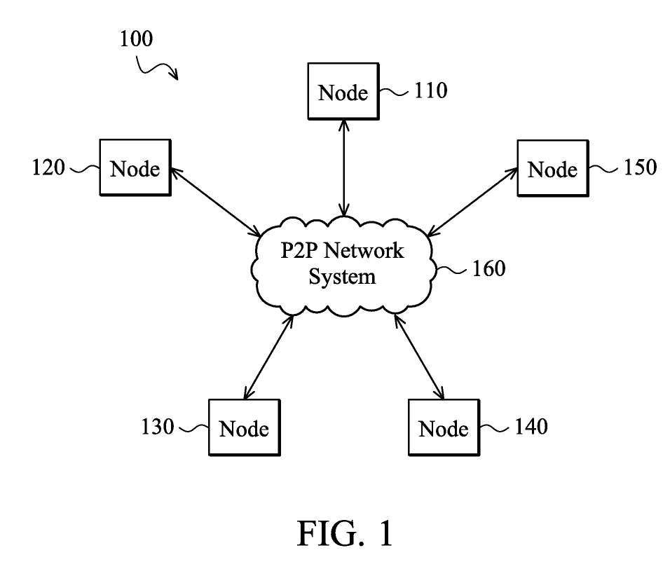

Several exemplary embodiments of the application are described with reference to FIGS. 1 through 13, which generally relate to node distribution. It is to be understood that the following disclosure provides various different embodiments as examples for implementing different features of the application. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The application discloses methods and devices for node distribution.

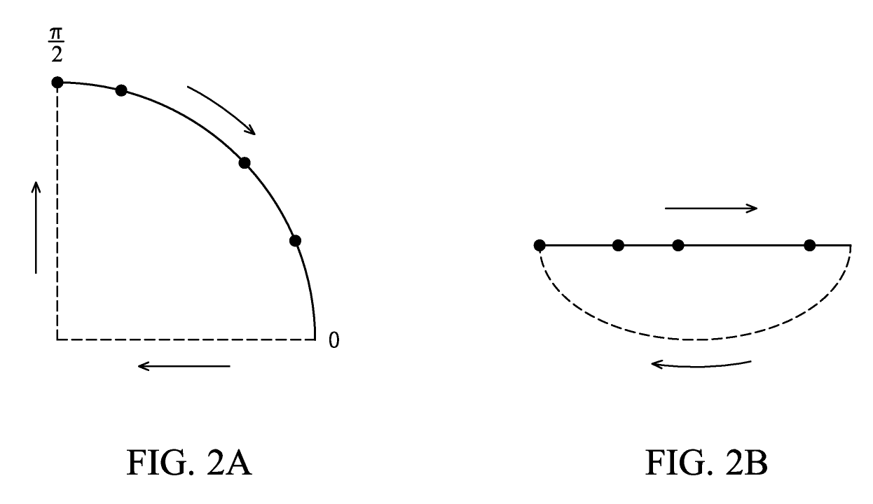

FIG. 1 is a schematic diagram for illustrating nodes joining a P2P network system according to an embodiment of the present application. In FIG. 1, the P2P network system 100 comprises a plurality of nodes (110, 120, 130, 140 and 150). Each node may search and share the documents through the mechanism of the node distribution via the structure of the P2P network node. It is noted that, each node in the P2P network is first mapped to a numerical space in the P2P network respectively by the mechanism of the node distribution. Referring to FIG. 2A and FIG. 2B, the numerical space may be defined by a numerical range, for example, a one-fourth circle where the range is 0˜π/2 (FIG. 2A) or a straight line (FIG. 2B). A node may join the P2P network along one of two sides in increasing and decreasing directions. Each node has a neighborhood table respectively. The neighborhood table records a certain number of nodes. The certain number of nodes recorded in the neighborhood table is close to the node which joins the P2P network along one of two sides in increasing and decreasing directions.

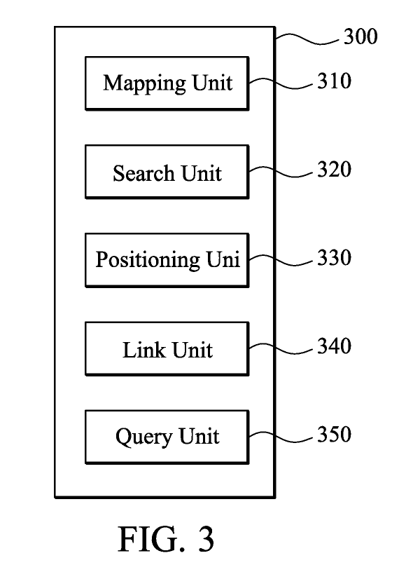

FIG. 3 is a schematic diagram illustrating an embodiment of a node distribution management device 300 of the present application. The node distribution management device 300 may be built in each node or other P2P systems. Although the method of the node distribution in the present application is illustrated with the node distribution management device 300 in FIG. 3, however, one of ordinary skill in the art can understand that the node distribution management device 300 and the method of the node distribution are not limited in the present application. The node distribution management device 300 may comprise at least one mapping unit 310, a search unit 320, a positioning unit 330, a link unit 340 and a query unit 350. When a target node wants to join the P2P network, the search unit 320 performs a search process in order to find a plurality of reference nodes distributed along one of two sides in increasing and decreasing direction in the numerical space. The search unit 320 finds any two consecutive nodes from the reference nodes. The two consecutive nodes are a first reference node and a second reference node. The second reference node is the node which is recorded in the neighborhood table of the first reference node and the distance between the first reference node and the second reference node conforms to a predetermined condition, for example, the distance between the first reference node and the second reference node is the maximum distance. The search unit 320 finds two positioning reference nodes, wherein the numerical distance conforms to the preset condition from a plurality of reference nodes, and maps the target node to a target value between the values corresponding to the two positioning reference nodes to determine the position of the target node in the P2P network, and informs the plurality of reference nodes of the position of the target node. The mapping unit 310 is configured to map the nodes of the application to a numerical space. The search unit 320 is configured to implement the search process of the application. The positioning unit 330 is configured to determine the position in which a new node joins the P2P network. The link unit 340 is configured to perform the document mapping and the link procedures, and the query unit 350 is configured to query a target document. Details will be described later.

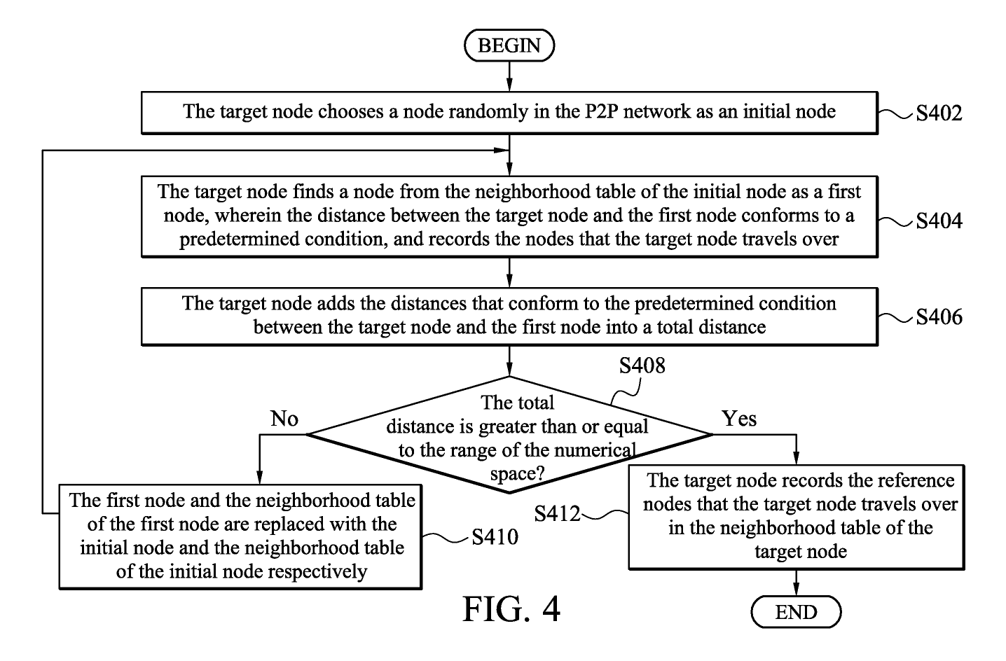

FIG. 4 is a flowchart illustrating an embodiment of a search process of the present application. In the embodiment, a target node records the reference nodes that the target node travels over, and determines the position in which the target node joins the P2P network.

In step S402, the target node chooses a node randomly in the P2P network as an initial node. In step S404, the target node finds a node from the neighborhood table of the initial node as a first node, wherein the distance between the target node and the first node conforms to a predetermined condition, and records the nodes that the target node travels over. In step S406, the target node adds the distances that conform to the predetermined condition between the target node and the first node into a total distance. In step S408, the search unit 320 determines whether the total distance is greater than or equal to the distance range of the numerical space. If the total distance is greater than or equal to the distance range of the numerical space (“Yes” in step S408), as shown in step S412, the target node records the reference nodes that the target node travels over in the neighborhood table of the target node and ends the search process. In another embodiment, the predetermined condition is that the distance is the maximum distance. It is noted that, in some embodiments, only the target node may be recorded in the neighborhood table of the target node because the target node may not find any node in the P2P network. If the total distance is smaller than the distance range of the numerical space (“No” in step S408) in step S410, the first node and the neighborhood table of the first node are replaced with the initial node and the neighborhood table of the initial node respectively, and repeats the above steps S404 and S406 recursively until the total distance is greater than or equal to the distance range of the numerical space, and then the search unit 320 obtains the reference nodes that the target node travels over.

Then, a positioning unit 330 finds two reference nodes with the maximum numerical distance from the reference nodes recorded in the neighborhood table of the target node. The target node is mapped to a target value between two values corresponding to two reference nodes by the mapping unit 310. The positioning unit 330 determines a position of the target node in the P2P network and locates the target node in the position, and then informs the reference nodes that the target node travels over the position of the target node.

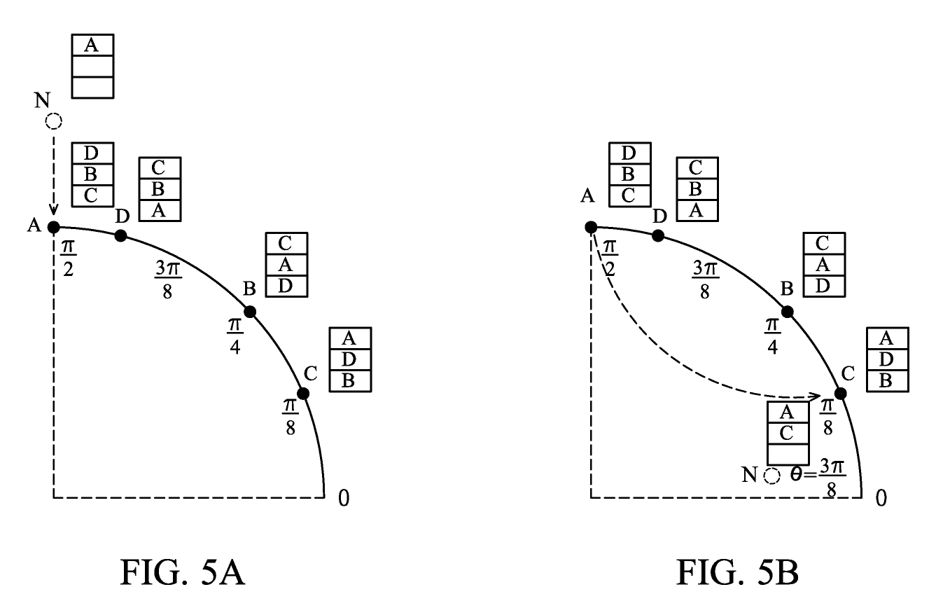

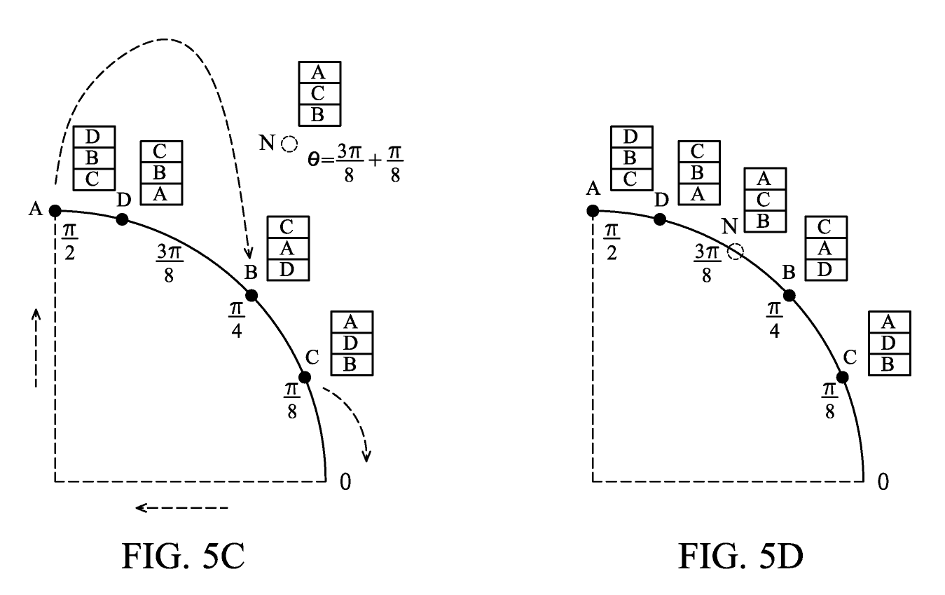

In an example, FIG. 5A is an example for illustrating a process where a node joins a P2P network. First, all nodes in the P2P network are mapped to a numerical space of the P2P network. For example, the numerical space is an angle space, wherein the angle range is 0˜π/2, wherein the range value is π/2. A node may join the P2P network along one of two sides in increasing and decreasing direction. In this embodiment, the node is along the side in decreasing direction. The P2P network includes the nodes A˜D, wherein each node has its neighborhood table respectively. First of all, a node N which wants to join the P2P network finds a node A, and finds a node C from the neighborhood table of the node A, wherein the distance between the node A and the node C confirms to a predetermined condition. In this example, the predetermined condition is that the distance is the maximum distance of the distances between the node A and the other nodes recorded in the neighborhood table of the node A. The node N records the route, the nodes, and the distances that the node N travels over, and adds the distances from the node A to the node C into a total distance θ, as shown in FIG. 5B. Then, the positioning unit 330 determines whether the total distance θ is greater than or equal to the distance range of the numerical space π/2. If the total number θ is smaller than the distance range of the numerical space π/2, the node N continues to look for a node B that has the furthest distance from the node C from the neighborhood table of the node C, as shown in FIG. 5C. The steps are repeated recursively until the total distance is greater than or equal to the distance range π/2.

Then, a positioning unit 330 finds two positioning nodes (the node A and the node C) from the nodes recorded in the neighborhood table of the node N, wherein the distance between the node A and the node C conforms to the predetermined condition. The node N is mapped to a numerical position between the two positioning nodes by the mapping unit 310. In this embodiment, the node N is located in the middle position between the node A and the node C (the corresponding value is A-(A-C)/2), as shown in FIG. 5D. The positioning unit 310 informs the nodes that the node N traveled over of the position of the node N.

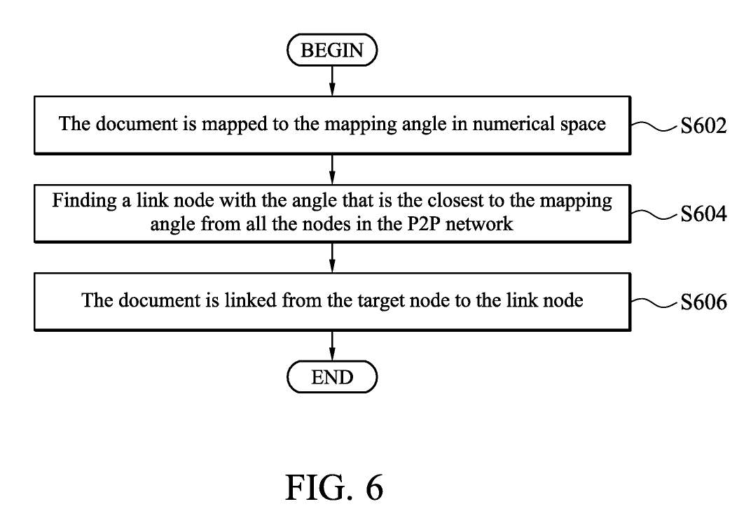

FIG. 6 is a flowchart illustrating an embodiment of the document mapping and linking of the present application. In this embodiment, after the target node joins the P2P network, the target node is further mapped to and links to the document to share the document in the P2P network.

A target node wants to share the document in the P2P network. As shown in S602, first, the document is mapped to the mapping angle in a numerical space. The link unit 340 extracts a first visual vector v_{z} based on a first visual feature domain F, and then the first visual vector v_{z} is mapped to an angle ω_{z} according to a conversion function. One embodiment of the conversion functions is as follows:

$$f ( {v}_{{z}^{′}} ) = {ω}_{z} = {cos}^{- 1} \frac{{v}_{{z}^{′}} \cdot {I}_{F}}{\vert {v}_{{z}^{′}} \vert \vert {I}_{F} \vert} ,$$

wherein v_{z′} is the normalization of the first visual vector v_{z}, and I_{F} is the vector of the first visual feature domain F. As in S604, the link unit 340 finds a link node with the angle that is the closest to the mapping angle from all of the nodes in the P2P network. As in S606, the document is linked from the target node to the link node. It is noted that, all of the nodes may be updated and re-link to the documents regularly to ensure that all the documents are linked to the nodes. Also, note that other visual feature domains, such as the color histogram, the homogeneous texture, or the region shape, and so on, are well-known for a person of ordinary skill in the art. An exemplary angle space and the conversion function were described above. Also, various well-known numerical spaces and corresponding conversion functions can be employed.

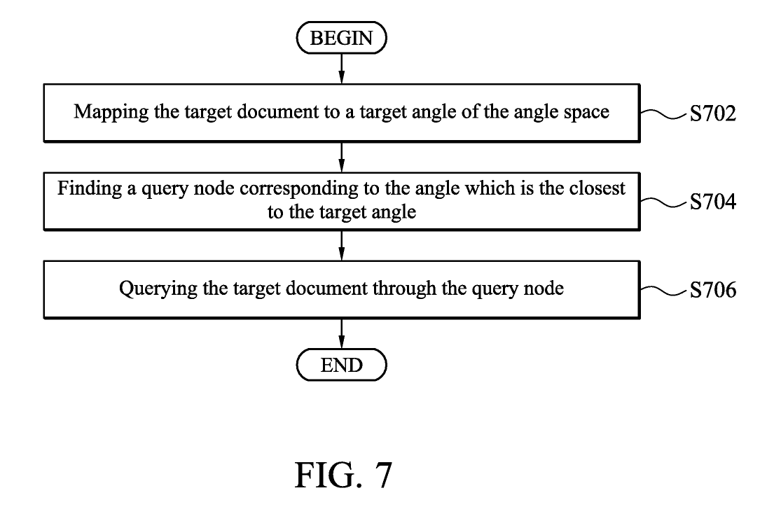

FIG. 7 is a flowchart of an embodiment in the present application. FIG. 7 illustrates the steps that are performed when any of nodes queries a target document in the P2P network. A node wants to query a target document. In step S702, the query unit 350 maps the target document to a target angle of the angle space based on a conversion function. As in S704, the query unit 350 finds a query node corresponding to the angle which is the closest to the target angle. As in S706, the node may query the target document through the query node. In some embodiments, a document may be mapped to the corresponding numerical space according to the conversion function, for example, a straight line. An exemplary angle space and the conversion function were described above. Also, various well-known numerical spaces and corresponding conversion functions can be employed.

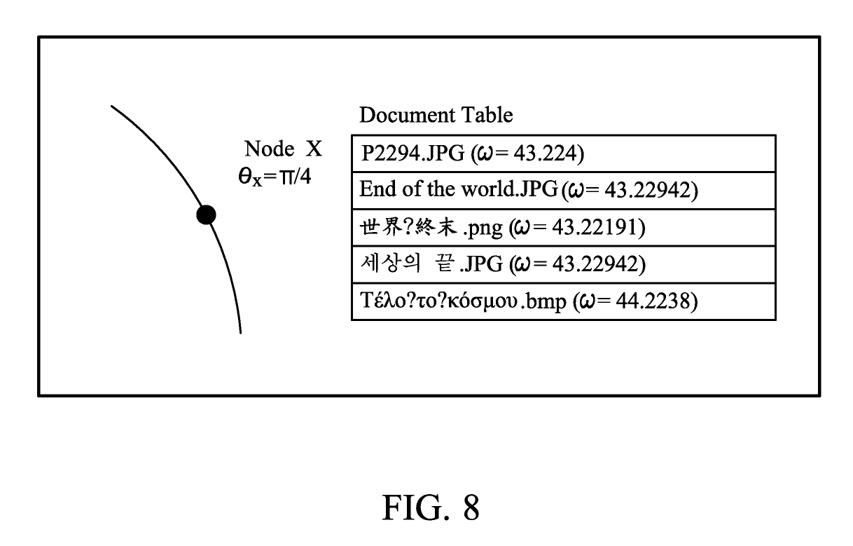

In some embodiments, the query unit 350 may further execute a similarity query for a document. First, when any node in the P2P network wants to query a target document, the query unit 350 maps from the target document to a target angle of the angle space based on a conversion function. Then, the query unit 350 finds at least one query node corresponding to an angle, wherein the angle range between the angle and the target angle is within a predetermined angle range. FIG. 8 is a schematic diagram illustrating the similarity query according to an embodiment of the present application. As shown in FIG. 8, the node X is linked to five documents. The contents of the documents (the documents are the image data in this embodiment) are the same, and the reason for the difference of the angles is caused by the different image compression technologies. In the traditional DHT network, even if the contents of the documents are the same, the documents are not linked meaningfully because of the characteristics of the hash function. However, the device may not only provide an accurate query in the present application, but also provide the similarity query through the mapping of the visual feature.

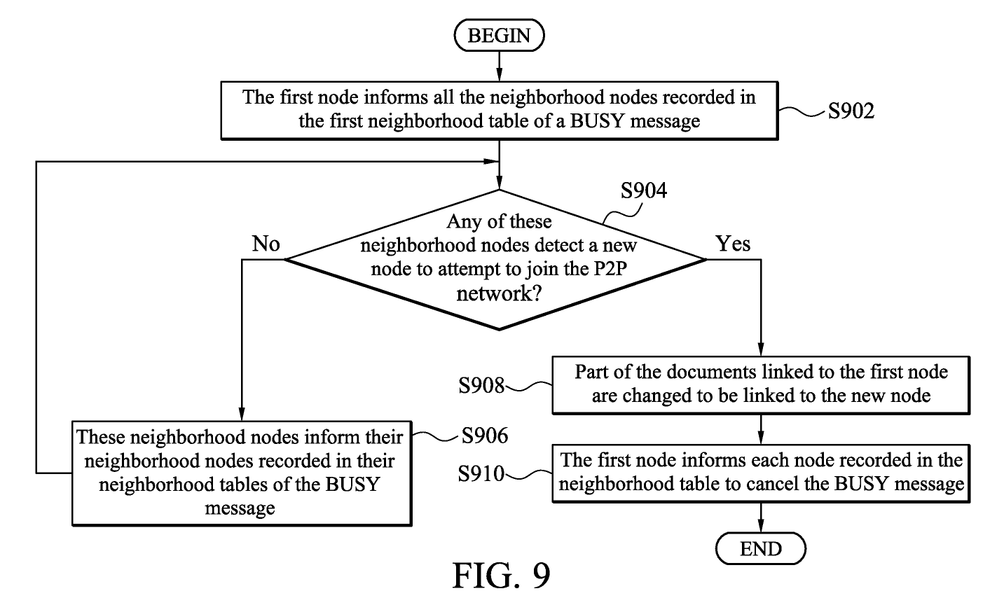

In the traditional DHT networks, some documents are linked to the same node, because the visual features of some documents are close. When the documents described above become popular, the documents cause an overload of the node easily, and the node can not share resources with each other in the P2P network. However, because the documents are distributed in the P2P network according to the visual feature, the documents may not be mapped and linked to the next node randomly. If the documents are mapped and linked to the nodes randomly, the links become useless. When a node wants to perform the query, the documents may not be queried by the node. Therefore, the nodes in the P2P network may achieve load balance without losing the characteristics of the links between the nodes and the documents through the mechanism of the present application. FIG. 9 is a flowchart illustrating an embodiment of load balance of the present application. The flowchart illustrates that when the link of a node is overloaded, the node performs the mechanism of the load balance.

When a first node is overloaded, as shown in step S902, the first node informs all of the neighborhood nodes recorded in the first neighborhood table of a BUSY message. If any of the neighborhood nodes does not detect a new node which is attempting to join the P2P network (“No” in step S904), as shown in step S906, the neighborhood nodes inform their neighborhood nodes recorded in their neighborhood tables of the BUSY message until any node detects a new node. If any of the neighborhood nodes detects a new node which is attempting to join the P2P network (“Yes” in step S904), as shown in step S908, part of the documents linked to the first node are changed to be linked to the new node. As shown in step S910, the first node informs each node recorded in the neighborhood table to cancel the BUSY message.

In some embodiments, the node distribution management device 300 further may perform the multi-dimensional query of the documents for different visual features and comparison reference standards. In the multi-dimensional query, there are different results of the queries in each visual feature. The node distribution management device 300 may utilize the union, the intersection or the weighting comparison of the results to obtain the best result of the query. First, the link unit 340 maps the document according to a conversion function, and extracts the second visual vector based on the second visual feature domain, and then maps the second visual vector to a second angle. The link unit 340 finds a second link node with an angle that is the closest to the second angle from all of the nodes in the P2P network. Finally, the document is linked from the target node to the second link node. In addition, the expansion of the dimensions also includes several features: the node distribution management device 300 does not need to re-arrange the position of each node. Because the nodes have been distributed averagely in each visual feature domain, there is no need to re-execute the entire process. When increasing a dimension, the system does not have to be out of service, and each node can also distribute the burden in addition to uploading/downloading the documents and storing the documents in order to achieve to distribute the nodes fast.

An exemplary visual feature and the conversion function are further described above. Various well-known visual features and corresponding conversion functions can be employed.

In some embodiments, when the target node leaves the P2P network, the target node delivers its neighborhood table to an alternate node which has the closest distance from the target node to the alternate node, and the documents linked to the target node originally are changed to be linked to the alternate node. It is noteworthy that, if the neighborhood table of the alternate node does not contain so many records, an overflow occurs in the neighborhood table of the alternate node. At this time, the alternate node integrates the neighborhood table of the target node into the neighborhood table of the alternate node, and then delivers the overflow of the neighborhood information to other alternate nodes. In this mode, the system may facilitate integration and update of the neighborhood table and may reduce the situation that there are other nodes in the middle of two adjacent neighborhood nodes in the neighborhood table.

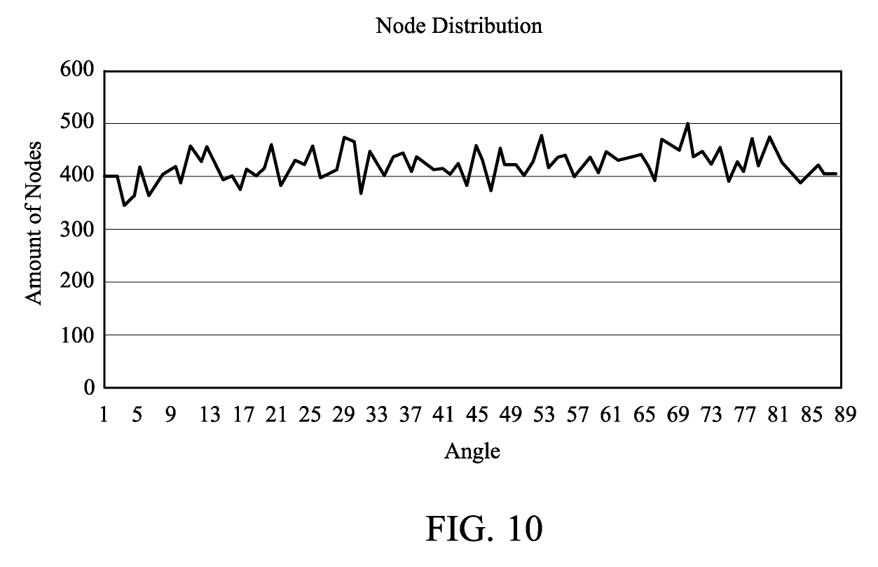

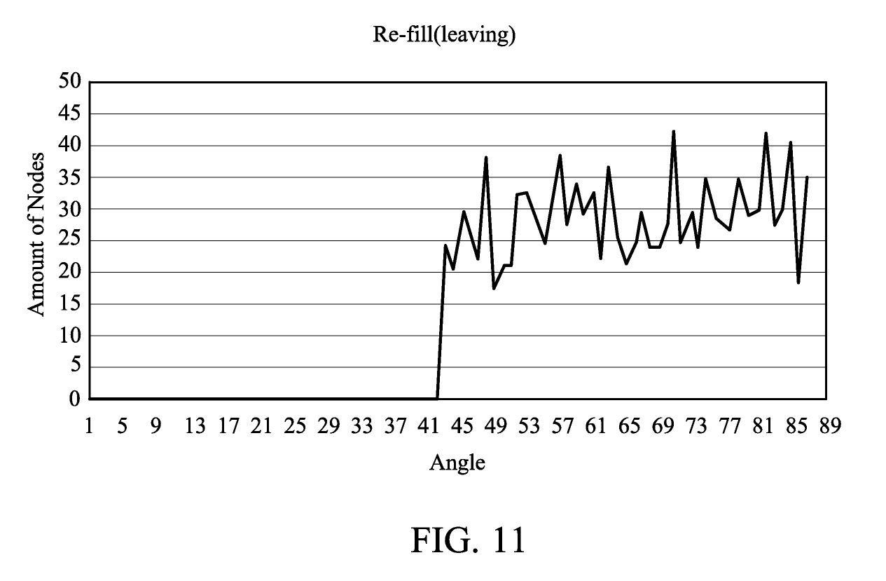

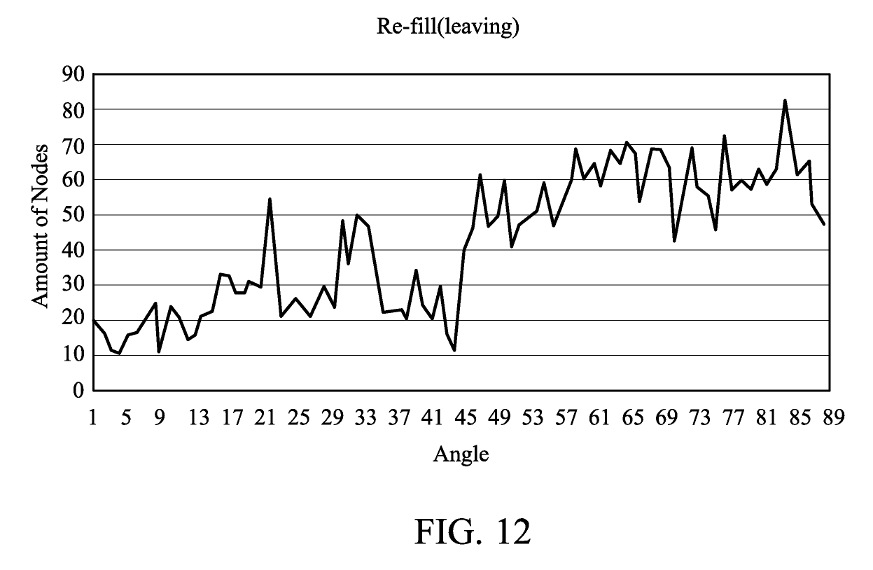

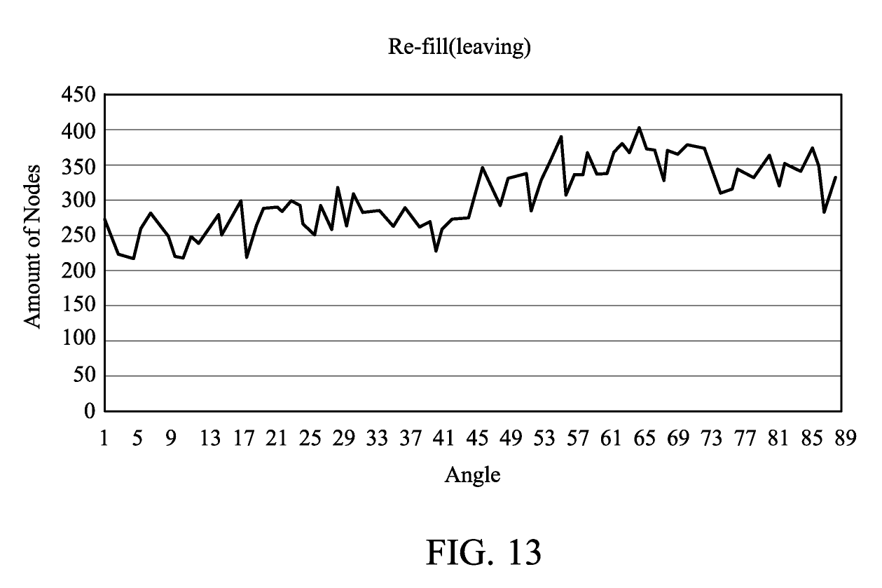

FIG. 10 is a schematic diagram illustrating the node distribution reaching balance distribution according to the method of the node distribution of the present application. The search process of the jumping mode in the present application may reduce a lot of calculations and still reach the balance of the node distribution without knowing the distribution of each node. FIGS. 11˜13 are schematic diagrams illustrating the condition of the node distribution after the nodes leave the network of the present application. As shown in FIGS. 11˜13, after the nodes leave the P2P network, the vacancies may be re-filled effectively. The node distribution may return to a steady state to reach the node distribution evenly. Therefore, the nodes may be distributed significantly and evenly in the P2P network through the methods and the devices for node distribution in the present application, and perform the query of the documents and the document sharing. When a node queries the documents, the query of the node may be limited to the conditions of the established categories, and also the query scope may be adjusted easily. In addition, the documents may be distributed in the P2P network independently according to the multi-dimension, and the standard of comparison may be expanded. When the P2P network adds the dimensions, the time of the node distribution is quick. When the dimension is transferred, the P2P network may not need to stop the services of the network until all of the nodes are re-distributed completely for improving the adaptability of the network services.

Methods for the node distribution, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the application has been described by way of example and in terms of the preferred embodiments, it is to be understood that the application is not limited to the disclosed embodiments. To the contrary, it is intended to cover various modifications and similar arrangements (as would be apparent to those skilled in the art). Therefore, the scopes of the appended claims should be accorded the broadest interpretation so as to encompass all such modifications and similar arrangements.

What is claimed is:

1. A method for node distribution, performed in at least one node distribution management device in a peer-to-peer (P2P) network system, comprising:
mapping all of the nodes in a P2P network to a numerical space respectively, wherein each of the nodes has a neighborhood table which are recorded a certain number of nodes and the certain number of nodes recorded in the neighborhood table are close to the node along one of two sides in increasing and decreasing directions;
performing a search process to find a plurality of reference nodes distributed along the direction in the numerical space, wherein any two consecutive reference nodes in a plurality of reference nodes are a first reference node and a second reference node, and the second reference node is the node which is in the neighborhood table of the first reference node and a distance between the second reference node and the first reference node conforms to a predetermined condition;
finding two positioning reference nodes, wherein the distance conforms to the predetermined condition from the reference nodes;
mapping a target node, to join the P2P network, to a target numerical value between two positioning reference nodes, and locating the target node in a position corresponding to the target numerical value in the P2P network; and
informing the reference nodes of the position of the target node.

2. The method for node distribution as claimed in claim 1, wherein the search process further comprises:
(a) choosing a node randomly in the P2P network as a third node;
(b) through a third neighborhood table of the third node, finding and recording a fourth node, wherein the distance between the third node and the fourth node conforms to the predetermined condition;
(c) adding the distances that conform to the predetermined condition between the third node and the fourth node into a total distance;
(d) if the total distance is smaller than a distance range of the numerical space, the fourth node and a fourth neighborhood table are replaced with the third node and the third neighborhood table respectively, and the above steps (b) and (c) are repeated recursively until the total distance is greater than or equal to the distance range and obtaining the reference nodes.

3. The method for node distribution as claimed in claim 2, wherein the numerical space is an angle space, wherein an angle range of the angle space is 0˜π/2, and the distance range of the angle range is π/2.

4. The method for distribution of nodes as claimed in claim 3, wherein after the target node joins the P2P network, the target node further performs a document mapping and linking process to share the document to the P2P network, and the method further comprises:
mapping the document to a mapping angle in the angle space;
finding a link node corresponding to an angle which is the closest to the mapping angle from the nodes in the P2P network; and
linking the document from the target node to the link node.

5. The method for node distribution as claimed in claim 4, wherein the steps of mapping the document, further comprises:
extracting a first visual vector based on a first visual feature domain of the document; and
mapping the first visual vector to a first angle.

6. The method for node distribution as claimed in claim 5, wherein the step of mapping the document according to a conversion function of:
$$f ( {v}_{{z}^{′}} ) = {ω}_{z} = {cos}^{- 1} \frac{{v}_{{z}^{′}} \cdot {I}_{F}}{\vert {v}_{{z}^{′}} \vert \vert {I}_{F} \vert} ,$$
wherein v_{z} is a first visual vector based on a first visual feature domain F of the document, v_{z′} is the normalization of the first visual vector v_{z}, I_{F} is a vector of the first visual feature domain F, and ω_{z} is the first angle in the first visual feature domain F of the document.

7. The method for node distribution as claimed in claim 4, wherein when any node in the P2P network wants to query a target document, the node performs the following:
mapping the target document to a target angle of the angle space;
finding a query node corresponding to an angle which is the closest to the target angle from all of the nodes in the P2P network; and
querying the target document through the query node.

8. The method for node distribution as claimed in claim 4, wherein when any node in the P2P network wants to query a target document, the node performs the following:
mapping the target document to a target angle in the angle space;
finding at least one query node corresponding to an angle, wherein an angle range between the angle and the target angle is within a predetermined angle range; and
querying the target document through at least one query node.

9. The method for node distribution as claimed in claim 1, wherein when the link of a first node in the P2P network is overloaded, the first node performs the following:
informing, by the first node, all of the neighborhood nodes recorded in a first neighborhood table of a BUSY message;
determining whether the neighborhood nodes detect a new node which is attempting to join the P2P network;
if any of the neighborhood nodes does not detect a new node which is attempting to join the P2P network, the neighborhood nodes inform their neighborhood nodes recorded in their neighborhood tables of the BUSY message; and
if any of the neighborhood nodes detects the new node which is attempting to join the P2P network, part of the documents linked to the first node are changed to be linked to the new node, and the first node informs each node recorded in the first neighborhood table to cancel the BUSY message.

10. The method for node distribution as claimed in claim 5, wherein the steps of mapping the document, further comprises:
extracting a second visual vector based on a second visual feature domain of the document; and
mapping the second visual vector to a second angle;
finding a second link node with the angle which is the closest to the second angle from all of the nodes in the P2P network; and
linking the document from the target node to the second link node.

11. The method for node distribution as claimed in claim 1, wherein when the target node wants to leave the P2P network, the target node delivers its neighborhood table to an alternate node which has the closest distance from the target node to the alternate node, and the documents linked to the target node originally are changed to be linked to the alternate node.

12. The method for node distribution as claimed in claim 1, wherein the preset condition is that the distance is the maximum distance.

13. The method for node distribution as claimed in claim 1, wherein the node distribution management device is installed in each node or other P2P network system.

14. A peer-to-peer (P2P) network system, comprising:
a plurality of nodes, capable of joining or leaving the P2P network, wherein each node has a neighborhood table which are recorded a certain number of nodes and the certain number of nodes recorded in the neighborhood table are close to the node along one of two sides in increasing and decreasing directions;
a node distribution management device, comprising:
a mapping unit, configured to map all of the nodes in a P2P network to the numerical space respectively;
a search unit, configured to find a plurality of reference nodes distributed along the direction in the numerical space, wherein any two consecutive reference nodes in a plurality of reference nodes are a first reference node and a second reference node, and the second reference node is the node which is in the neighborhood table of the first reference node and a distance between the second reference node and the first reference node conforms to a predetermined condition;
a positioning unit, configured to find two positioning reference nodes, wherein the distance conforms to the predetermined condition from the reference nodes, and the mapping unit maps a target node which wants to join the P2P network to a target numerical value between two positioning reference nodes; and
the positioning unit locates the target node in a position corresponding to the target numerical value in the P2P network, and informs the reference nodes of the position of the target node.

15. The P2P network system as claimed in claim 14, wherein the search unit performs a search process to find a plurality of reference nodes distributed along the numerical direction, and the search process comprises:
(a) choosing a node randomly in the P2P network as a third node;
(b) through a third neighborhood table of the third node, finding and recording a fourth node, wherein the distance between the third node and the fourth node conforms to the predetermined condition;
(c) adding the distances that conform to the predetermined condition between the third node and the fourth node into a total distance;
(d) if the total distance is smaller than a distance range of the numerical space, the fourth node and a fourth neighborhood table are replaced with the third node and the third neighborhood table respectively, and the above steps (b) and (c) are repeated recursively until the total distance is greater than or equal to the distance range and obtaining the reference nodes.

16. The P2P network system as claimed in claim 15, wherein the numerical space is an angle space, wherein an angle range of the angle space is 0˜π/2, and the distance range of the angle range is π/2.

17. The P2P network system as claimed in claim 16, wherein the node distribution management device further comprises a link unit, wherein after the target node joins the P2P network, the target node further performs a document mapping and linking process to share the document in the P2P network, and the process of the document mapping and linking comprises:
mapping the document to a mapping angle in the angle space;
finding a link node corresponding to an angle which is the closest to the mapping angle from all of the nodes in the P2P network; and
linking the document from the target node to the link node.

18. The P2P network system as claimed in claim 17, wherein the steps of mapping the document by the link unit comprises the steps of:
extracting a first visual vector based on a first visual feature domain of the document; and
mapping the first visual vector to a first angle.

19. The P2P network system as claimed in claim 17, further comprising a query unit, wherein when any node in the P2P network wants to query a target document, the node, through the query unit, performs the following steps of:
mapping the target document to a target angle in the angle space;
finding a query node corresponding to an angle which is the closest to the target angle from all of the nodes in the P2P network; and
querying the target document through the query node.

20. The P2P network system as claimed in claim 14, wherein when the link of a first node in the P2P network is overloaded, the first node performs the following steps of:
informing, by the first node, all of the neighborhood nodes recorded in a first neighborhood table of a BUSY message;
determining whether the neighborhood nodes detects a new node which is attempting to join the P2P network;
if any of the neighborhood nodes does not detects the new node which is attempting to join the P2P network, the neighborhood nodes inform their neighborhood nodes recorded in their neighborhood tables of the BUSY message; and
if any of the neighborhood nodes detects the new node which is attempting to join the P2P network, part of the documents linked to the first node are changed to be linked to the new node, the first node informs each node recorded in the first neighborhood table to cancel the BUSY message.

21. The P2P network system as claimed in claim 18, wherein the step of mapping the document by the link unit further comprises the steps of:
extracting a second visual vector based on a second visual feature domain of the document; and
mapping the second visual vector to a second angle;
finding a second link node with the angle which is the closest to the second angle from all of the nodes in the P2P network; and
linking the document from the target node to the second link node.

22. The P2P network system as claimed in claim 14, wherein the preset condition is that the numerical distance is the maximum distance.

23. The P2P network system as claimed in claim 14, wherein the node distribution management device is installed in each node or other P2P network system.

24. A machine-readable storage medium comprising a computer program, which, when executed, causes a device to perform a method for node distribution in a peer-to-peer (P2P) network, wherein the P2P network comprises a plurality of nodes, joining or leaving the P2P network, wherein each node has a neighborhood table which are recorded a certain number of nodes and the certain number of nodes recorded in the neighborhood table are close to the node along one of two sides in increasing and decreasing directions; and the method comprises:
mapping all of the nodes in a P2P network to a numerical space respectively;
performing a search process to find a plurality of reference nodes distributed along the numerical direction in the numerical space, wherein any two consecutive reference nodes in a plurality of reference nodes are a first reference node and a second reference node, and the second reference node is the node which is in the neighborhood table of the first reference node and the distance between the second reference node and the first reference node conforms to a predetermined condition;
finding two positioning reference nodes, wherein the distance conforms to the predetermined condition from the reference nodes;
mapping a target node to a target numerical value between two positioning reference nodes, and locating the target node in a position corresponding to the target numerical value in the P2P network; and
informing the reference nodes of the position of the target node.

25. The machine-readable storage medium as claimed in claim 24, wherein the search process comprises the steps of:
(a) choosing a node randomly in the P2P network as a third node;
(b) through a third neighborhood table of the third node, finding and recording a fourth node, wherein the distance between the third node and the fourth node conforms to the predetermined condition;
(c) adding the distances that conform to the predetermined condition between the third node and the fourth node into a total distance;
(d) if the total distance is smaller than a distance range of the numerical space, the fourth node and a fourth neighborhood table are replaced with the third node and the third neighborhood table respectively, and the above steps (b) and (c) are repeated recursively until the total distance is greater than or equal to the distance range and obtaining the reference nodes.

26. The machine-readable storage medium as claimed in claim 25, wherein the numerical space is an angle space, wherein an angle range of the angle space is 0˜π/2, and the distance range of the angle range is π/2.

27. The machine-readable storage medium as claimed in claim 26, wherein after the target node joins the P2P network, the target node further performs a document mapping and linking process to share the document in the P2P network, and the method comprises the steps of:
mapping the document to a mapping angle in the angle space;
finding a link node corresponding to an angle which is the closest to the mapping angle from all of the nodes in the P2P network; and
linking the document from the target node to the link node.

28. The machine-readable storage medium as claimed in claim 27, wherein the steps of mapping the document, comprises the steps of:
extracting a first visual vector based on a first visual feature domain of the document; and
mapping the first visual vector to a first angle.

29. The machine-readable storage medium as claimed in claim 27, wherein when any node in the P2P network wants to query a target document, the node performs the following steps of:
mapping the target document to a target angle of the angle space;
finding a query node corresponding to an angle which is the closest to the target angle from all of the nodes in the P2P network; and
querying the target document through the query node.

30. The machine-readable storage medium as claimed in claim 24, wherein when the link of a first node in the P2P network is overloaded, the first node performs the following steps of:
informing, by the first node, all of the neighborhood nodes recorded in a first neighborhood table of a BUSY message;
determining whether the neighborhood nodes detect a new node which is attempting to join the P2P network;
if any of the neighborhood nodes does not detect a new node which is attempting to join the P2P network, the neighborhood nodes inform their neighborhood nodes recorded in their neighborhood tables of the BUSY message; and
if any of the neighborhood nodes detects the new node which is attempting to join the P2P network, part of the documents linked to the first node are changed to be linked to the new node, wherein the first node informs each node recorded in the first neighborhood table to cancel the BUSY message.

31. The machine-readable storage medium as claimed in claim 28, wherein the steps of mapping the document, further comprises the steps of:
extracting a second visual vector based on a second visual feature domain of the document; and
mapping the second visual vector to a second angle;
finding a second link node with the angle which is the closest to the second angle from all of the nodes in the P2P network; and
linking the document from the target node to the second link node.

32. The machine-readable storage medium as claimed in claim 24, wherein the preset condition is that the distance is the maximum distance.
